(19) United States
(12) Patent Application Publication
(10) Pub. No.: US 2022/0375164 A1
(43) Pub. Date: Nov. 24, 2022

(54) METHOD AND APPARATUS FOR THREE DIMENSIONAL RECONSTRUCTION, ELECTRONIC DEVICE AND STORAGE MEDIUM

(71) Applicant: BEIJING DAJIA INTERNET INFORMATION TECHNOLOGY CO., LTD., Beijing (CN)

(72) Inventor: Tian Chen, Beijing (CN)

(73) Assignee: BEIJING DAJIA INTERNET INFORMATION TECHNOLOGY CO., LTD., Beijing (CN)

(21) Appl. No.: 17/651,318

(22) Filed: Feb. 16, 2022

(30) Foreign Application Priority Data
May 21, 2021 (CN) 202110556202.4

(51) Int. Cl. G06T 17/20; G06T 7/50; G06T 7/73; G06T 7/38

(52) U.S. Cl. CPC G06T 17/20; G06T 7/50; G06T 7/73; G06T 7/38; G06T 2207/10028

(57) ABSTRACT

A method for 3D reconstruction includes: acquiring an image sequence of an object to be reconstructed continuously acquired by a monocular image collector; extracting depth information of an image to be processed in the image sequence; estimating translation attitude information of the image to be processed based on world coordinate information of each feature point in a reference image, image coordinate information of each feature point in the image to be processed, and rotation attitude information of the image to be processed, the reference image being an adjacent image whose acquisition time point in the image sequence is located before the image to be processed; generating a point cloud image based on the depth information, the rotation attitude information and the translation attitude information of each image; and performing 3D reconstruction on the object to be reconstructed based on the point cloud image.

### CROSS REFERENCE TO RELATED APPLICATIONS

This application is based on and claim priority to Chinese Patent Application No. 202110556202.4, filed on May 21, 2021, the content of which is incorporated herein by reference in its entirety.

### TECHNICAL FIELD

The disclosure relates to the field of computer technologies.

### BACKGROUND

At present, when three-dimensional (3D) reconstruction is performed on a mobile terminal, it is necessary to install a depth sensor on the mobile terminal, such as a depth camera, to obtain depth information of an image.

### SUMMARY

According to a first aspect of the disclosure, a method for three-dimensional (3D) reconstruction includes acquiring an image sequence of an object to be reconstructed, in which the image sequence comprises a plurality of images of the object to be reconstructed continuously acquired by a monocular image collector; extracting depth information of an image to be processed in the image sequence; estimating translation attitude information of the image to be processed based on world coordinate information of each feature point in a reference image, image coordinate information of each feature point in the image to be processed, and rotation attitude information of the image to be processed, in which the reference image is an adjacent image whose acquisition time point in the image sequence is located before the image to be processed; generating a point cloud image based on the depth information, the rotation attitude information and the translation attitude information of each image in the image sequence; and performing 3D reconstruction on the object to be reconstructed based on the point cloud image.

According to a second aspect of the disclosure, an apparatus for three-dimensional (3D) reconstruction includes a processor and a memory for storing instructions executable by the processor. The processor is configured to acquire an image sequence of an object to be reconstructed, in which the image sequence includes a plurality of images of the object to be reconstructed continuously acquired by a monocular image collector; extract depth information of an image to be processed in the image sequence; estimate translation attitude information of the image to be processed based on world coordinate information of each feature point in a reference image, image coordinate information of each feature point in the image to be processed, and rotation attitude information of the image to be processed, wherein the reference image is an adjacent image whose acquisition time point in the image sequence is located before the image to be processed; generate a point cloud image based on the depth information, the rotation attitude information and the translation attitude information of each image in the image sequence; and perform 3D reconstruction on the object to be reconstructed based on the point cloud image.

According to a third aspect of the disclosure, a non-transitory computer-readable storage medium is stored with instructions. When the instructions are executed by a processor of an electronic device, the electronic device is enabled to execute the method as described in the first aspect of the disclosure.

It should be understood that the above general description and the following detailed description are only exemplary and explanatory, without any limitations to the disclosure.

### BRIEF DESCRIPTION OF THE DRAWINGS

The drawings herein are incorporated into the specification and constitute a part of the specification, show embodiments in accordance with the disclosure, and are used to explain the principle of the disclosure together with the specification, which do not constitute an improper limitation to the disclosure.

FIG. 1 is a flowchart illustrating a method for three-dimensional (3D) reconstruction according to some embodiments.

FIG. 2 is a structural diagram illustrating a deep network model according to some embodiments.

FIG. 3 is a flowchart illustrating another method for three-dimensional (3D) reconstruction according to some embodiments.

FIG. 4 is a diagram illustrating 15 basic modes.

FIG. 5 is a block diagram illustrating an apparatus for three-dimensional (3D) reconstruction according to some embodiments.

FIG. 6 is a block diagram illustrating an electronic device for three-dimensional (3D) reconstruction according to some embodiments.

### DETAILED DESCRIPTION

In order to make those skilled in the art better understand the technical solutions of the disclosure, the technical solutions in the embodiments of the disclosure will be clearly and thoroughly described below with reference to the accompanying drawings.

It should be noted that the terms such as “first” and “second” in the specification, claims and the above-mentioned drawings of the disclosure are used to distinguish similar objects, and not necessarily used to describe a specific sequence or precedence order. It should be understood that the data used in this way may be interchanged under appropriate circumstances so that the embodiments of the disclosure described herein may be implemented in an order other than those illustrated or described herein. The implementations described in the example embodiments below do not represent all implementations consistent with the disclosure. Rather, they are merely examples of apparatuses and methods consistent with some aspects of the disclosure as detailed in the appended claims.

In the related art, attitude information of the mobile terminal is determined by combining the image and the depth information of the image. Then, the 3D reconstruction is performed on an object in the image, in combination with the attitude information of the mobile terminal, the image and the depth information of the image.

For the problem in the related art that it is necessary to install a depth sensor on the mobile terminal with high costs, and it is also necessary to improve the adaptability and scalability, the disclosure provides a method for 3D reconstruction. With the method for 3D reconstruction according to embodiments of the disclosure, the image sequence of the object to be reconstructed is acquired, in which the image sequence is a continuous image frame obtained by image acquisition of the object to be reconstructed by a monocular image collector; depth information of the image to be processed in the image sequence is extracted; translation attitude information of the image to be processed is estimated based on world coordinate information of each feature point in a reference image, image coordinate information of each feature point in the image to be processed, and rotation attitude information of the image to be processed, in which the reference image is an adjacent image whose acquisition time point in the image sequence is located before the image to be processed; a point cloud image is generated based on the depth information, the rotation attitude information and the translation attitude information of each image in the image sequence; 3D reconstruction is performed on the object to be reconstructed based on the point cloud image. In this way, the 3D reconstruction on the object to be reconstructed is achieved by only a monocular image collector without using a depth sensor, which overcomes the defect of limited measuring range of the depth sensor, reduces costs with good adaptability and expansibility.

The method for 3D reconstruction according to embodiments of the disclosure is described in detail below with reference to drawings.

FIG. 1 is a flowchart illustrating a method for three-dimensional (3D) reconstruction according to some embodiments. It should be noted that, the method for 3D reconstruction in the embodiment of the disclosure may be executed by an apparatus for 3D reconstruction that may be configured in an electronic device without installing a depth sensor, so that the electronic device performs 3D construction on the object to be constructed.

The electronic device may be any static or mobile computing device capable of data processing, such as mobile computing devices such as notebook computers and wearable devices, or static computing devices such as desktop computers, or other types of computing devices, which are not limited by the embodiments of the disclosure.

As shown in FIG. 1, the method for 3D reconstruction may include the following steps at S101-S105.

At S101, an image sequence of an object to be reconstructed is acquired. The image sequence is a continuous image frame of the object to be reconstructed acquired by a monocular image collector.

The object to be reconstructed may be any object or any space area for example. The image sequence is a continuous image frame of the object to be reconstructed acquired by the monocular image collector from various angles. The monocular image collector may be a single camera on a mobile computing device for example.

At S102, for an image to be processed in the image sequence, depth information of the image to be processed is extracted.

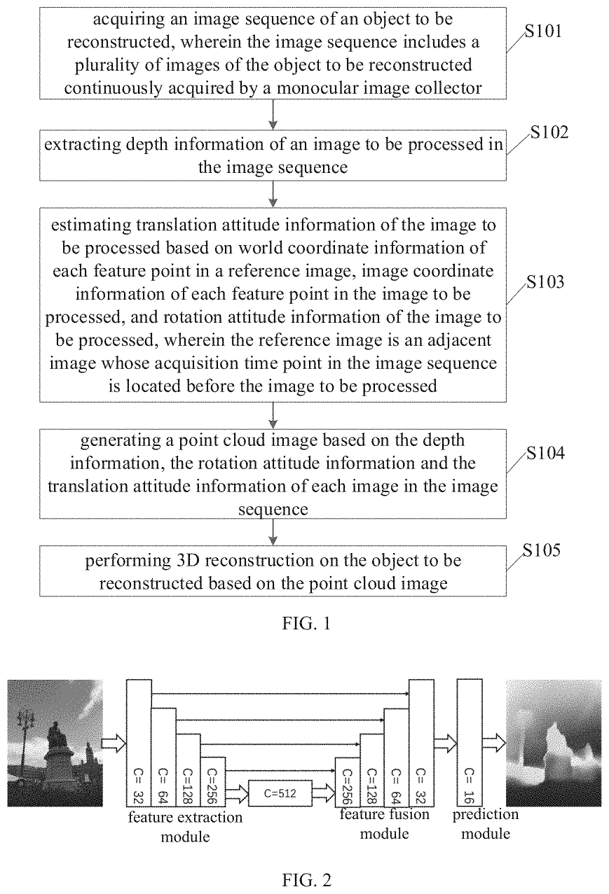

Extracting the depth information of the image to be processed by the 3D reconstruction apparatus may include obtaining the depth information of the image to be processed by inputting the image to be processed into a preset depth network model. The structural diagram of the depth network model can be shown in FIG. 2. In FIG. 2, the structure of the depth network model may include: a feature extraction module, a feature fusion module and a prediction module. The feature extraction module is mainly configured to extract features of the image from a low level to a high level. The feature fusion module is configured to gradually restore image resolution and reduce a number of channels, and obtain a fusion feature by fusing the high-level feature and low-level feature extracted by the feature extraction module. The prediction module is mainly configured to predict a depth value of each pixel in the image based on the feature of each pixel in the fusion feature.

The method for training the depth network model may include obtain training data, in which the training data includes each sample image and corresponding depth information; and training an initial depth network model by using each sample image and the corresponding depth information, so as to obtain the trained depth network model.

At S103, translation attitude information of the image to be processed is estimated based on world coordinate information of each feature point in a reference image, image coordinate information of each feature point in the image to be processed, and rotation attitude information of the image to be processed. The reference image is an adjacent image whose acquisition time point in the image sequence is located before the image to be processed;

In some embodiments, the monocular image collector can be configured with an inertial measurement unit (IMU) for measuring in real time inertial measurement information of the image collector, so as to obtain the inertial measurement information of the image collector in collecting the image to be processed. The inertial measurement information can include the rotation attitude information. It should be noted that the rotation attitude information refers to an angle deviation of a first attitude relative to a second attitude of the image collector. The first attitude is an attitude of the image collector in collecting the image to be processed. The second attitude is an attitude of the image collector in collecting the first image in the image sequence.

In the above embodiment, the rotation attitude information of the image collector in collecting the image to be processed can be obtained directly by setting an inertial measurement unit on the monocular image collector, and then the translation attitude information can be determined conveniently in combination with the rotation attitude information, so as to improve the rate and accuracy of determining the translation attitude information.

In the exemplary embodiment, since the position of the object to be reconstructed is fixed and does not move with the movement of the image collector, the world coordinate information of the object to be reconstructed is identical in a plurality of images continuously captured by the image collector. Furthermore, in the continuous shooting process of the image collector, the attitude change of the image collector in shooting two adjacent images is limited without a significant change. Based on this principle, six-degree of freedom (DOF) attitude constraints can thus be constructed. The translation attitude information can be solved under the condition of the six-DOF attitude constraints, which can improve the accuracy of solving the translation attitude information. The six degrees of freedom refer to DOFs of movement along three rectangular coordinate axes of x, y and z in the world coordinate system and DOFs of rotation around the three rectangular coordinate axes. Therefore, the step at 103 performed by the 3D reconstruction apparatus may include for example, acquiring world coordinate information of each feature point in the reference image; determining image coordinate information of each feature point in the image to be processed by performing optical flow tracking on each feature point in the reference image; constructing an equation set by taking the translation attitude information of the image to be processed as a variable, taking the world coordinate information of each feature point in the reference image, the image coordinate information of each feature point in the image to be processed, and the rotation attitude information of the image to be processed as parameters, and taking a six-degree of freedom attitude constraint as a condition, and obtaining the translation attitude information of the image to be processed by solving the equation set.

In the above embodiment, the algorithm for solving the translation attitude information of the image to be processed using the above solving principle may be for example, a perspective-n-point (PNP) imaging algorithm. The method for extracting each feature point in the image may include obtaining each feature point in the image by performing good feature to track (GFTT). It should be noted that the translation attitude information is position offset information of the first attitude of the image collector relative to the second attitude. The first attitude is an attitude of the image collector in collecting the image to be processed. The second attitude is an attitude of the image collector in collecting the first image in the image sequence.

At S104, a point cloud image is generated based on the depth information, the rotation attitude information and the translation attitude information of each image in the image sequence.

In the exemplary embodiment, the world coordinate information of each pixel point in each image can be directly determined based on the depth information, the rotation attitude information and the translation attitude information of each image in the image sequence; then the point cloud image can be generated in combination with the world coordinate information of each pixel point in each image, which can improve the rate and accuracy of generating the point cloud image. Therefore, the step at 104 performed by the 3D reconstruction apparatus may include, for example, for each image of the image sequence, determining image collector position information corresponding to the image to be processed based on the rotation attitude information of the image to be processed, the translation attitude information of the image to be processed, and the image collector position information corresponding to a first image in the image sequence; determining world coordinate information of each pixel point in the image to be processed based on the image collector position information corresponding to the image to be processed and the depth information of the image to be processed; and generating the point cloud image based on the world coordinate information of each pixel point in each image.

In the above embodiment, the rotation attitude information and shift attitude information of the image to be processed are offset information between the first attitude and the second attitude. The first attitude is an attitude of the image collector in collecting the image to be processed. The second attitude is an attitude of the image collector in collecting the first image in the image sequence. Therefore, the image collector position information corresponding to the image to be processed can be determined in combination with the rotation attitude information, the translation attitude information of the image to be processed and the image collector position information corresponding to the first image in the image sequence.

In the above embodiment, the depth information of the image to be processed refers to distance offset information of each pixel point in the image to be processed relative to the image collector on the fixed coordinate axis or the fixed orientation determined by multiple coordinate axes. Therefore, the world coordinate information of each pixel point in the image to be processed can be determined in combination with the image collector position information corresponding to the image to be processed and the depth information of the image to be processed,.

At S105, 3D reconstruction is performed on the object to be reconstructed based on the point cloud image.

With the method for 3D reconstruction according to embodiments of the disclosure, the image sequence of the object to be reconstructed is acquired, in which the image sequence is a continuous image frame obtained by image acquisition of the object to be reconstructed by a monocular image collector; depth information of the image to be processed in the image sequence is extracted; translation attitude information of the image to be processed is estimated based on world coordinate information of each feature point in a reference image, image coordinate information of each feature point in the image to be processed, and rotation attitude information of the image to be processed, in which the reference image is an adjacent image whose acquisition time point in the image sequence is located before the image to be processed; a point cloud image is generated based on the depth information, the rotation attitude information and the translation attitude information of each image in the image sequence; 3D reconstruction is performed on the object to be reconstructed based on the point cloud image. In this way, the 3D reconstruction on the object to be reconstructed is achieved by only a monocular image collector without using a depth sensor, which overcomes the defect of limited measuring range of the depth sensor, reduces costs with good adaptability and expansibility.

The process of performing 3D reconstruction on the object to be reconstructed based on the point cloud image in the method for 3D reconstruction according to the embodiment of the present disclosure, is described below in combination with FIG. 3. FIG. 3 is a flowchart illustrating another method for three-dimensional (3D) reconstruction according to some embodiments.

As shown in FIG. 3, the step at S105 shown in FIG. 1 may further include the following steps at S301-S304.

At S301, each voxel block is obtained by spatially meshing the point cloud image.

In the exemplary embodiment, a number of voxel blocks can be set, and the point cloud image can be spatially meshed to obtain the number of voxel blocks. Alternatively, the size of the voxel block can be set, and the point cloud image can be spatially meshed based on the set size to obtain a plurality of voxel blocks. A voxel block may include multiple voxels, and the voxel is the smallest structure in the voxel block.

At S302, a voxel block through which a ray passes is determined by performing ray projection processing on the point cloud image with each pixel point of each image in the image sequence as a starting point.

In the exemplary embodiment, in order to facilitate storage and query of voxel blocks and improve the querying efficiency, after the step at 302, the 3D reconstruction apparatus can also perform the following steps:

for the voxel block passed by the ray with each pixel point as the starting point, determining a hash value corresponding to the voxel block based on space position information of the voxel block; determining a target storage area of the voxel block by querying a hash table based on the hash value corresponding to the voxel block, in which the hash table stores a mapping relationship between hash values and storage areas; and finding the voxel block in the target storage area. The voxel block is stored in the storage area corresponding to the hash value based on the corresponding hash value.

In the above embodiment, the method for determining the hash value corresponding to the voxel block based on the space position information of the voxel block includes: determining world coordinate information of the lower left corner pixel in the voxel block, in which the world coordinate information includes an X axis coordinate, a Y axis coordinate and a Z axis coordinate; determining a preset coding value corresponding to each axis and determining a number of storage areas; calculating a sum of products of the coordinates at respective axes and the preset coding values, and performing mod operation on the sum and the number of storage areas to obtain the hash value corresponding to the voxel block.

At S303, each iso-surface and corresponding position information are determined based on the voxel block through which the ray with each pixel point as the starting point passes. A truncated signed distance function (TSDF) value of each voxel block in the iso-surface is identical, and the TSDF value of the voxel block is determined based on a ray length from the voxel block to the pixel point.

In some embodiments, each voxel block accordingly has a truncated signed distance function (TSDF) and a weight value. The TSDF of the voxel block is obtained by fusing the TSDF value of each voxel in the voxel block with the weight value.

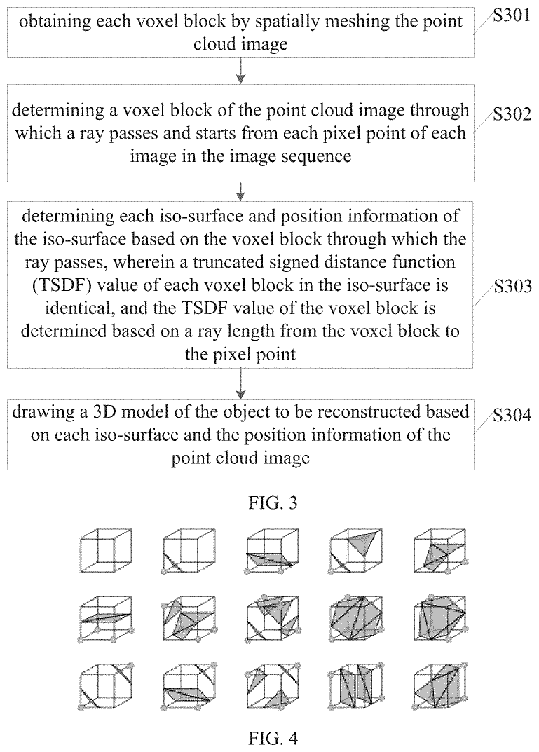

In the above embodiment, after the iso-surface is determined, the iso-surface is accurately represented with voxels in the voxel block. Specifically, intersections of the iso-surface with voxel edges can be connected based on a relative position between each vertex of the voxel and the iso-surface, to determine an approximate representation of the iso-surface in the voxel. For each voxel, its each vertex value has two cases (i.e., greater than or smaller than the current value of the iso-surface). There are 256 cases with 8 vertices in total. Considering the rotational symmetry, 15 basic modes shown in FIG. 4 can be obtained after reclassification. These cases are encoded into a voxel state table. According to a vertex index in the voxel state table, position coordinates of the iso-surface and edges in the voxel can be quickly calculated. Finally, a normal vector of each vertex in the iso-surface is obtained by vector cross product, so as to determine the position information of the iso-surface.

At S304, a 3D model of the object to be reconstructed is drawn based on each iso-surface and the corresponding position information.

With the method for 3D reconstruction according to embodiments of the disclosure, the image sequence of the object to be reconstructed is acquired, in which the image sequence is a continuous image frame obtained by image acquisition of the object to be reconstructed by a monocular image collector; depth information of the image to be processed in the image sequence is extracted; translation attitude information of the image to be processed is estimated based on world coordinate information of each feature point in a reference image, image coordinate information of each feature point in the image to be processed, and rotation attitude information of the image to be processed, in which the reference image is an adjacent image whose acquisition time point in the image sequence is located before the image to be processed; a point cloud image is generated based on the depth information, the rotation attitude information and the translation attitude information of each image in the image sequence; each voxel block is obtained by spatially meshing the point cloud image; the voxel block through which the ray passes is determined by performing ray projection processing on the point cloud image with each pixel point of each image in the image sequence as the starting point; each iso-surface and corresponding position information are determined based on the voxel block through which the ray with each pixel point as the starting point passes, in which the TSDF value of each voxel block in the iso-surface is identical, and the TSDF value of the voxel block is determined based on the ray length from the voxel block to the pixel point; and the 3D model of the object to be reconstructed is drawn based on each iso-surface and the corresponding position information. In this way, the 3D reconstruction on the object to be reconstructed is achieved by only a monocular image collector without using a depth sensor, which overcomes the defect of limited measuring range of the depth sensor, reduces costs with good adaptability and expansibility. Furthermore, the iso-surface is accurately determined by performing ray projection processing, which improves the 3D reconstruction rate.

In order to achieve the above embodiments, an apparatus for three-dimensional (3D) reconstruction is provided in the embodiments of the disclosure.

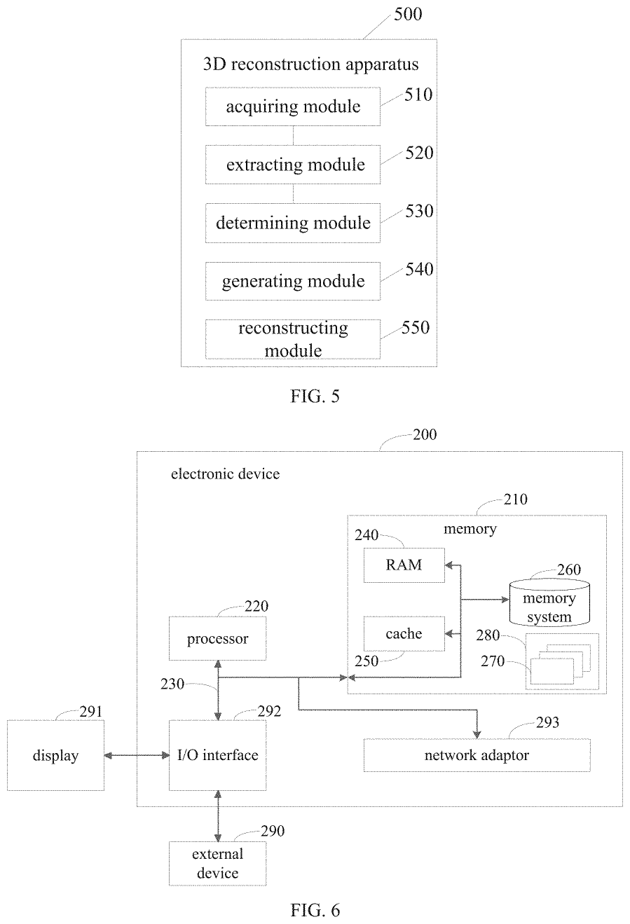

FIG. 5 is a block diagram illustrating an apparatus for 3D reconstruction according to some embodiments. As shown in FIG. 5, the apparatus 500 for 3D reconstruction may include an acquiring module 510, an extracting module 520, a determining module 530, a generating module 540 and a reconstructing module 550.

The acquiring module 510 is configured to perform acquiring an image sequence of an object to be reconstructed, wherein the image sequence is a continuous image frame of the object to be reconstructed acquired by a monocular image collector.

The extracting module 520 is configured to perform extracting depth information of an image to be processed in the image sequence.

The determining module 530 is configured to perform estimating translation attitude information of the image to be processed based on world coordinate information of each feature point in a reference image, image coordinate information of each feature point in the image to be processed, and rotation attitude information of the image to be processed, in which the reference image is an adjacent image whose acquisition time point in the image sequence is located before the image to be processed.

The generating module 540 is configured to perform generating a point cloud image based on the depth information, the rotation attitude information and the translation attitude information of each image in the image sequence.

The reconstructing module 550 is configured to perform 3D reconstruction on the object to be reconstructed based on the point cloud image.

In some embodiments, the acquiring module 510 is further configured to perform acquiring inertial measurement information of the image collector in collecting the image to be processed, in which the inertial measurement information includes the rotation attitude information.

In some embodiments, the determining module 530 is further configured to perform: acquiring world coordinate information of each feature point in the reference image; determining image coordinate information of each feature point in the image to be processed by performing optical flow tracking on each feature point in the reference image; and constructing an equation set by taking the translation attitude information of the image to be processed as a variable, taking the world coordinate information of each feature point in the reference image, the image coordinate information of each feature point in the image to be processed, and the rotation attitude information of the image to be processed as parameters, and taking a six degree of freedom attitude constraint as a condition, and obtaining the translation attitude information of the image to be processed by solving the equation set.

In some embodiments, the generating module 540 is further configured to perform: for each image of the image sequence, determining image collector position information corresponding to the image to be processed based on the rotation attitude information of the image to be processed, the translation attitude information of the image to be processed, and image collector position information corresponding to a first image in the image sequence; determining world coordinate information of each pixel point in the image to be processed based on the image collector position information corresponding to the image to be processed and the depth information of the image to be processed; and generating the point cloud image based on the world coordinate information of each pixel point in each image.

In some embodiments, the reconstructing module 550 is further configured to perform: obtaining each voxel block by spatially meshing the point cloud image; determining a voxel block through which a ray passes by performing ray projection processing on the point cloud image with each pixel point of each image in the image sequence as a starting point; determining each iso-surface and corresponding position information based on the voxel block through which the ray with each pixel point as the starting point passes, wherein a truncated signed distance function (TSDF) value of each voxel block in the iso-surface is identical, and the TSDF value of the voxel block is determined based on a ray length from the voxel block to the pixel point; and drawing a 3D model of the object to be reconstructed based on each iso-surface and the corresponding position information.

In some embodiments, the reconstructing module 550 is further configured to perform: for the voxel block passed by the ray with each pixel point as the starting point, determining a hash value corresponding to the voxel block based on space position information of the voxel block; determining a target storage area of the voxel block by querying a hash table based on the hash value corresponding to the voxel block, wherein the hash table stores a mapping relationship between hash values and storage areas; and finding the voxel block in the target storage area.

It should be noted that, the 3D reconstruction apparatus according to the embodiments of the disclosure may perform the above method for 3D reconstruction. The 3D reconstruction apparatus may be an electronic device or configured in the electronic device, so that 3D reconstruction is executed in the electronic device.

The electronic device may be any static or mobile computing device capable of data processing, such as a mobile computing device such as a notebook computer, a wearable device, a static computing device such as a desktop computer, or other types of computing devices, which are not limited by the embodiments of the disclosure.

It should be noted that, as for the apparatus in the above embodiment, the specific way of operations performed by each module has been described in detail in the method embodiment, which will not be described in detail here.

With the apparatus for 3D reconstruction according to embodiments of the disclosure, the image sequence of the object to be reconstructed is acquired, in which the image sequence is a continuous image frame obtained by image acquisition of the object to be reconstructed by a monocular image collector; depth information of the image to be processed in the image sequence is extracted; translation attitude information of the image to be processed is estimated based on world coordinate information of each feature point in a reference image, image coordinate information of each feature point in the image to be processed, and rotation attitude information of the image to be processed, in which the reference image is an adjacent image whose acquisition time point in the image sequence is located before the image to be processed; a point cloud image is generated based on the depth information, the rotation attitude information and the translation attitude information of each image in the image sequence; 3D reconstruction is performed on the object to be reconstructed based on the point cloud image. In this way, the 3D reconstruction on the object to be reconstructed is achieved by only a monocular image collector without using a depth sensor, which overcomes the defect of limited measuring range of the depth sensor, reduces costs with good adaptability and expansibility.

In order to achieve the above embodiments, an electronic device is also provided in the embodiments of the disclosure. The electronic device 200 includes a processor 220, and a memory 210 stored with instructions executable by the processor 220. The processor 220 is configured to execute the instructions to implement any of the above methods for 3D reconstruction.

As an example, FIG. 6 is a block diagram illustrating an electronic device 200 for three-dimensional (3D) reconstruction according to some embodiments. As shown in FIG. 6, the electronic device 200 may also include a bus 230 connected to different components (including the memory 210 and the processor 220). The memory 210 is stored with computer programs. When the processor 220 is configured to execute the computer programs, the above methods for 3D reconstruction is implemented according to the embodiments of the disclosure.

The bus 230 represents one or more of several types of bus structures, including a memory bus or memory controller, a peripheral bus, a graphics acceleration port, a processor, or a local bus using any of a variety of bus structures. For example, these architectures include but are not limited to an industry standard architecture (ISA) bus, a micro-channel architecture (MAC) bus, an enhanced ISA bus, a video electronics standards association (VESA) local bus and a peripheral component interconnection (PCI) bus.

The electronic device 200 typically includes a variety of computer-readable media. These media may be any available media that may be accessed by the electronic device 200, including volatile and non-volatile media, removable and non-removable media.

The memory 210 may also include a computer system readable medium in the form of a volatile memory, for example, a random access memory (RAM) 240 and/or a cache memory 250. The electronic device 200 may also include other removable/non-removable, volatile/non-volatile computer system storage media. For example only, a storage system 260 may be configured to read and write non-removable, non-volatile magnetic media (which is not shown in FIG. 6, commonly referred to as “a hard disk drive”). Although not shown in FIG. 6, a disk drive for reading and writing to a removable non-volatile disk (such as a “floppy disk”) and an optical disk drive for reading and writing a removable non-volatile optical disc may be provided (e.g., a CD-ROM, a DVD-ROM or other optical media). In these cases, each drive may be connected to the bus 230 through one or more data media interfaces. The memory 210 may include at least one program product having a set of (e.g., at least one) program modules configured to perform the functions of various embodiments of the present disclosure.

The program/utility 280 with a set of (at least one) program module 270 may be stored in the memory 210, for example. Such program module 270 includes, but is not limited to, an operating system, one or more application programs, other program modules, and program data. Each or some combination of these examples may include an implementation of a network environment. The program module 270 is usually configured to execute functions and/or methods in the embodiments described in the disclosure.

The electronic device 200 may also communicate with one or more external devices 290 (e. g., a keyboard, a pointing device, a display 291, etc.), with one or more devices that enable the user to interact with the electronic device 200, and/or with any device that enables the electronic device 200 to communicate with one or more other computing devices (e.g., a network card, a modem, etc.). Such communication can be carried out via an input/output (I/O) interface 292. In addition, the electronic device 200 can also communicate with one or more networks (e.g., a local area network (LAN), a wide area network (WAN) and/or public network, such as the Internet) through a network adapter 293. As shown in FIG. 6, the network adapter 293 communicates with other modules of the electronic device 200 through the bus 230. It should be understood that although not shown in FIG. 6, other hardware and/or software modules can be used in conjunction with the electronic device 200, including but not limited to: micro-codes, device drivers, redundant processing units, external disk drive arrays, RAID systems, tape drives, and data backup storage systems.

The processor 220 executes various functional applications and data processing by running programs stored in the memory 210.

It should be noted that the implementation process and technical principle of the electronic device in this embodiment refer to the foregoing explanation of the 3D reconstruction method in the embodiment of the present disclosure, which will not be repeated here.

With the electronic device according to embodiments of the disclosure, the image sequence of the object to be reconstructed is acquired, in which the image sequence is a continuous image frame obtained by image acquisition of the object to be reconstructed by a monocular image collector; depth information of the image to be processed in the image sequence is extracted; translation attitude information of the image to be processed is estimated based on world coordinate information of each feature point in a reference image, image coordinate information of each feature point in the image to be processed, and rotation attitude information of the image to be processed, in which the reference image is an adjacent image whose acquisition time point in the image sequence is located before the image to be processed; a point cloud image is generated based on the depth information, the rotation attitude information and the translation attitude information of each image in the image sequence; 3D reconstruction is performed on the object to be reconstructed based on the point cloud image. In this way, the 3D reconstruction on the object to be reconstructed is achieved by only a monocular image collector without using a depth sensor, which overcomes the defect of limited measuring range of the depth sensor, reduces costs with good adaptability and expansibility.

In order to realize the above embodiments, an embodiment of the disclosure also provides a non-transitory computer-readable storage medium.

When instructions in the computer-readable storage medium are executed by a processor of an electronic device, the electronic device is enabled to execute the method for 3D reconstruction as described above.

In order to realize the above embodiments, the present disclosure also provides a computer program product that, when executed by a processor of an electronic device, the electronic device is enabled to execute the method for 3D reconstruction as described above.

After considering the description and practicing the disclosure disclosed herein, those skilled in the art will easily think of other embodiments of the present disclosure. The present disclosure aims to cover any variation, usage or adaptive change of the present disclosure, which follows the general principles of the present disclosure and includes the common knowledge or conventional means in the art not disclosed in the present disclosure. The description and embodiments are only regarded as exemplary, and the true scope and spirit of the present disclosure are pointed out by the following claims.

It should be understood that the disclosure is not limited to the precise structure already described above and shown in the drawings, and various modifications and changes may be made without departing from its scope. The scope of the disclosure is limited only by the appended claims.

What is claimed is:

1. A method for three-dimensional (3D) reconstruction, comprising:
acquiring an image sequence of an object to be reconstructed, wherein the image sequence comprises a plurality of images of the object to be reconstructed continuously acquired by a monocular image collector;
extracting depth information of an image to be processed in the image sequence;
estimating translation attitude information of the image to be processed based on world coordinate information of each feature point in a reference image, image coordinate information of each feature point in the image to be processed, and rotation attitude information of the image to be processed, wherein the reference image is an adjacent image whose acquisition time point in the image sequence is located before the image to be processed;
generating a point cloud image based on the depth information, the rotation attitude information and the translation attitude information of each image in the image sequence; and
performing 3D reconstruction on the object to be reconstructed based on the point cloud image.

2. The method of claim 1, further comprising:
acquiring inertial measurement information of the monocular image collector in collecting the image to be processed, wherein the inertial measurement information comprises the rotation attitude information.

3. The method of claim 1, wherein estimating translation attitude information of the image to be processed comprises:
acquiring world coordinate information of each feature point in the reference image;
determining the image coordinate information of each feature point in the image to be processed by performing optical flow tracking on each feature point in the reference image; and
constructing an equation set by taking the translation attitude information of the image to be processed as a variable, taking the world coordinate information of each feature point in the reference image, the image coordinate information of each feature point in the image to be processed, and the rotation attitude information of the image to be processed as parameters, and taking a six-degree of freedom attitude constraint as a condition, and obtaining the translation attitude information of the image to be processed by solving the equation set.

4. The method of claim 1, wherein generating the point cloud image comprises:
for each image of the image sequence, determining second position information of the monocular image collector in collecting the image to be processed based on the rotation attitude information of the image to be processed, the translation attitude information of the image to be processed, and first position information of the monocular image collector in collecting a first image in the image sequence;
determining world coordinate information of each pixel point in the image to be processed based on the second position information and the depth information of the image to be processed; and
generating the point cloud image based on the world coordinate information of each pixel point in each image.

5. The method of claim 1, wherein performing 3D reconstruction on the object to be reconstructed comprises:
obtaining each voxel block by spatially meshing the point cloud image;
determining a voxel block of the point cloud image through which a ray passes and starts from each pixel point of each image in the image sequence;
determining each iso-surface and position information of the iso-surface based on the voxel block through which the ray passes, wherein a truncated signed distance function (TSDF) value of each voxel block in the iso-surface is identical, and the TSDF value of the voxel block is determined based on a ray length from the voxel block to the pixel point; and
drawing a 3D model of the object to be reconstructed based on each iso-surface and the position information of the point cloud image.

6. The method of claim 5, further comprising:
for the voxel block through which the ray passes, determining a hash value corresponding to the voxel block based on space position information of the voxel block;
determining a target storage area of the voxel block by querying a hash table based on the hash value corresponding to the voxel block, wherein the hash table stores a mapping relationship between hash values and storage areas; and
finding the voxel block in the target storage area.

7. The method of claim 6, wherein determining the hash value corresponding to the voxel block comprises:
determining world coordinate information of the lower left corner pixel in the voxel block, in which the world coordinate information comprises coordinates at respective axes;
determining a preset coding value corresponding to each axis and determining a number of storage areas;
calculating a sum of products of the coordinates at respective axes with the preset coding values; and
determining the hash value corresponding to the voxel block by performing mod operation on the sum and the number of storage areas.

8. The method of claim 6, wherein determining position information of the iso-surface comprises:
calculating position coordinates of the iso-surface relative to voxel edges based on a vertex index in a voxel state table, wherein the voxel state table is encoded in advance;
determining a normal vector of each vertex in the iso-surface by vector cross product; and
determining position information of the iso-surface based on the position coordinates of the iso-surface and the normal vector.

9. An apparatus for three-dimensional (3D) reconstruction, comprising:
a processor; and
a memory for storing instructions executable by the processor;
wherein the processor is configured to acquire an image sequence of an object to be reconstructed, wherein the image sequence comprises a plurality of images of the object to be reconstructed continuously acquired by a monocular image collector;
extract depth information of an image to be processed in the image sequence;
estimate translation attitude information of the image to be processed based on world coordinate information of each feature point in a reference image, image coordinate information of each feature point in the image to be processed, and rotation attitude information of the image to be processed, wherein the reference image is an adjacent image whose acquisition time point in the image sequence is located before the image to be processed;
generate a point cloud image based on the depth information, the rotation attitude information and the translation attitude information of each image in the image sequence; and
perform 3D reconstruction on the object to be reconstructed based on the point cloud image.

10. The apparatus of claim 9, wherein the processor is further configured to acquire inertial measurement information of the monocular image collector in collecting the image to be processed, wherein the inertial measurement information comprises the rotation attitude information.

11. The apparatus of claim 9, wherein the processor is further configured to:
acquire world coordinate information of each feature point in the reference image;
determine the image coordinate information of each feature point in the image to be processed by performing optical flow tracking on each feature point in the reference image; and
construct an equation set by taking the translation attitude information of the image to be processed as a variable, taking the world coordinate information of each feature point in the reference image, the image coordinate information of each feature point in the image to be processed, and the rotation attitude information of the image to be processed as parameters, and taking a six degree of freedom attitude constraint as a condition, and obtaining the translation attitude information of the image to be processed by solving the equation set.

12. The apparatus of claim 9, wherein the processor is further configured to:
for each image of the image sequence, determine second position information of the monocular image collector in collecting the image to be processed based on the rotation attitude information of the image to be processed, the translation attitude information of the image to be processed, and first position information of the monocular image collector in collecting a first image in the image sequence;
determining world coordinate information of each pixel point in the image to be processed based on the second position information and the depth information of the image to be processed; and
generate the point cloud image based on the world coordinate information of each pixel point in each image.

13. The apparatus of claim 9, wherein the processor is further configured to:
obtain each voxel block by spatially meshing the point cloud image;
determine a voxel block of the point cloud image through which a ray passes and starts from each pixel point of each image in the image sequence;
determine each iso-surface and position information of the iso-surface based on the voxel block through which the ray with each pixel point as the starting point passes, wherein a truncated signed distance function (TSDF) value of each voxel block in the iso-surface is identical, and the TSDF value of the voxel block is determined based on a ray length from the voxel block to the pixel point; and
draw a 3D model of the object to be reconstructed based on each iso-surface and the corresponding position information.

14. The apparatus of claim 13, wherein the processor is further configured to:
for the voxel block through which the ray passes, determine a hash value corresponding to the voxel block based on space position information of the voxel block;
determine a target storage area of the voxel block by querying a hash table based on the hash value corresponding to the voxel block, wherein the hash table stores a mapping relationship between hash values and storage areas; and
find the voxel block in the target storage area.

15. A non-transitory computer-readable storage medium having instructions stored thereon, wherein when the instructions are executed by a processor of an electronic device, the electronic device is enabled to execute a method for three-dimensional (3D) reconstruction, the method comprising:
acquiring an image sequence of an object to be reconstructed, wherein the image sequence comprises continuous images of the object to be reconstructed acquired by a monocular image collector;
extracting depth information of an image to be processed in the image sequence;
estimating translation attitude information of the image to be processed based on world coordinate information of each feature point in a reference image, image coordinate information of each feature point in the image to be processed, and rotation attitude information of the image to be processed, wherein the reference image is an adjacent image whose acquisition time point in the image sequence is located before the image to be processed;
generating a point cloud image based on the depth information, the rotation attitude information and the translation attitude information of each image in the image sequence; and
performing 3D reconstruction on the object to be reconstructed based on the point cloud image.

16. The storage medium of claim 15, wherein the method further comprises:
acquiring inertial measurement information of the monocular image collector in collecting the image to be processed, wherein the inertial measurement information comprises the rotation attitude information.

17. The storage medium of claim 15, wherein estimating translation attitude information of the image to be processed comprises:
acquiring world coordinate information of each feature point in the reference image;
determining the image coordinate information of each feature point in the image to be processed by performing optical flow tracking on each feature point in the reference image; and
constructing an equation set by taking the translation attitude information of the image to be processed as a variable, taking the world coordinate information of each feature point in the reference image, the image coordinate information of each feature point in the image to be processed, and the rotation attitude information of the image to be processed as parameters, and taking a six-degree of freedom attitude constraint as a condition, and obtaining the translation attitude information of the image to be processed by solving the equation set.

18. The storage medium of claim 15, wherein generating the point cloud image comprises:
for each image of the image sequence, determining second position information of the monocular image collector in collecting the image to be processed based on the rotation attitude information of the image to be processed, the translation attitude information of the image to be processed, and first position information of the monocular image collector in collecting a first image in the image sequence;
determining world coordinate information of each pixel point in the image to be processed based on the second position information and the depth information of the image to be processed; and
generating the point cloud image based on the world coordinate information of each pixel point in each image.

19. The storage medium of claim 15, wherein performing 3D reconstruction on the object to be reconstructed comprises:
obtaining each voxel block by spatially meshing the point cloud image;
determining a voxel block of the point cloud image through which a ray passes and starts from each pixel point of each image in the image sequence;
determining each iso-surface and position information of the iso-surface based on the voxel block through which the ray passes, wherein a truncated signed distance function (TSDF) value of each voxel block in the iso-surface is identical, and the TSDF value of the voxel block is determined based on a ray length from the voxel block to the pixel point; and
drawing a 3D model of the object to be reconstructed based on each iso-surface and the position information of the point cloud image.

20. The storage medium of claim 19, wherein the method further comprises:
for the voxel block through which the ray passes, determining a hash value corresponding to the voxel block based on space position information of the voxel block;
determining a target storage area of the voxel block by querying a hash table based on the hash value corresponding to the voxel block, wherein the hash table stores a mapping relationship between hash values and storage areas; and
finding the voxel block in the target storage area.
